(19) United States
(12) Patent Application Publication
(10) Pub. No.: US 2018/0276310 A1
(43) Pub. Date: Sep. 27, 2018

(54) INFORMATION PROCESSING SYSTEM, INFORMATION PROCESSING METHOD, AND COMPUTER PROGRAM PRODUCT

(71) Applicant: Kabushiki Kaisha Toshiba, Minato-ku (JP)

(72) Inventors: Hidenori MATSUZAKI, Fuchu (JP); Akira KURODA, Yokohama (JP); Xinxiao LI, Yokohama (JP); Dan UMEDA, Nerima (JP)

(73) Assignee: Kabushiki Kaisha Toshiba, Minato-ku (JP)

(21) Appl. No.: 15/689,723

(22) Filed: Aug. 29, 2017

(30) Foreign Application Priority Data
Mar. 22, 2017 (JP) 2017-056492

(51) Int. Cl. G06F 17/30

(52) U.S. Cl. CPC G06F 17/30952; G06F 17/30994

(57) ABSTRACT

According to an embodiment, an information processing system includes one or more memories and one or more processors coupled to the memories. The one or more processors are configured to receive a start time and an end time, and use time series information including data for which time information is associated with numerical information and index information including data for which a time range of the time information is associated with tabulation information tabulated for each time range of the time information, refer to the tabulation information associated with time information between the time range including the start time and the time range including the end time, and extract the tabulation information corresponding to a period between the start time and the end time.

### CROSS-REFERENCE TO RELATED APPLICATIONS

This application is based upon and claims the benefit of priority from Japanese Patent Application No. 2017-056492, filed on Mar. 22, 2017; the entire contents of which are incorporated herein by reference.

### FIELD

Embodiments described herein relate generally to an information processing system, an information processing method, and a computer program product.

### BACKGROUND

Conventionally, time series information such as event information concerning the operation of software or hardware has been used. A user can, by referring to the time series information visualized in a display form such as a graph, comprehend more easily a state that the time series information indicates.

In the conventional technology, however, when using tabulation information obtained from the time series information, increasing the processing speed has been difficult.

### BRIEF DESCRIPTION OF THE DRAWINGS

FIG. 1 is a diagram illustrating an example of a functional configuration of an information processing system according to an embodiment;

FIG. 2 is a diagram illustrating an example in time series information in the embodiment;

FIG. 3A is a diagram illustrating an example of index information in the embodiment;

FIG. 3B is a diagram illustrating an example of display information that a display controller in the embodiment outputs;

FIG. 3C is a diagram illustrating an example of the display information that the display controller in the embodiment outputs;

FIG. 3D is a chart that a GUI system displayed based on the display information in the embodiment;

FIG. 3E is a diagram illustrating another example of the display made by the GUI system in the embodiment;

FIG. 4 is an overall flowchart illustrating an example of an information processing method in the embodiment;

FIG. 5A is a flowchart illustrating a sequence of processing performed in acquiring the index information from trace information in the embodiment;

FIG. 5B is a diagram illustrating an internal table used in acquiring the index information from the trace information in the embodiment;

FIG. 6 is a flowchart illustrating an example of an extraction method of range information on numerical information in the embodiment;

FIG. 7 is a diagram illustrating an example of a hardware configuration of the information processing system in the embodiment;

FIG. 8 is a diagram illustrating an example of a case where the information processing system in the embodiment is separated; and

FIG. 9 is a diagram illustrating an example of a hardware configuration of the case where the information processing system is separated.

### DETAILED DESCRIPTION

According to an embodiment, an information processing system includes one or more memories and one or more processors coupled to the memories. The one or more processors are configured to receive a start time and an end time, and use time series information including data for which time information is associated with numerical information and index information including data for which a time range of the time information is associated with tabulation information tabulated for each time range of the time information, refer to the tabulation information associated with time information between the time range including the start time and the time range including the end time, and extract the tabulation information corresponding to a period between the start time and the end time.

With reference to the accompanying drawings, the following describes in detail an exemplary embodiment of an information processing system, an information processing method, and a program product.

Example of Functional Configuration

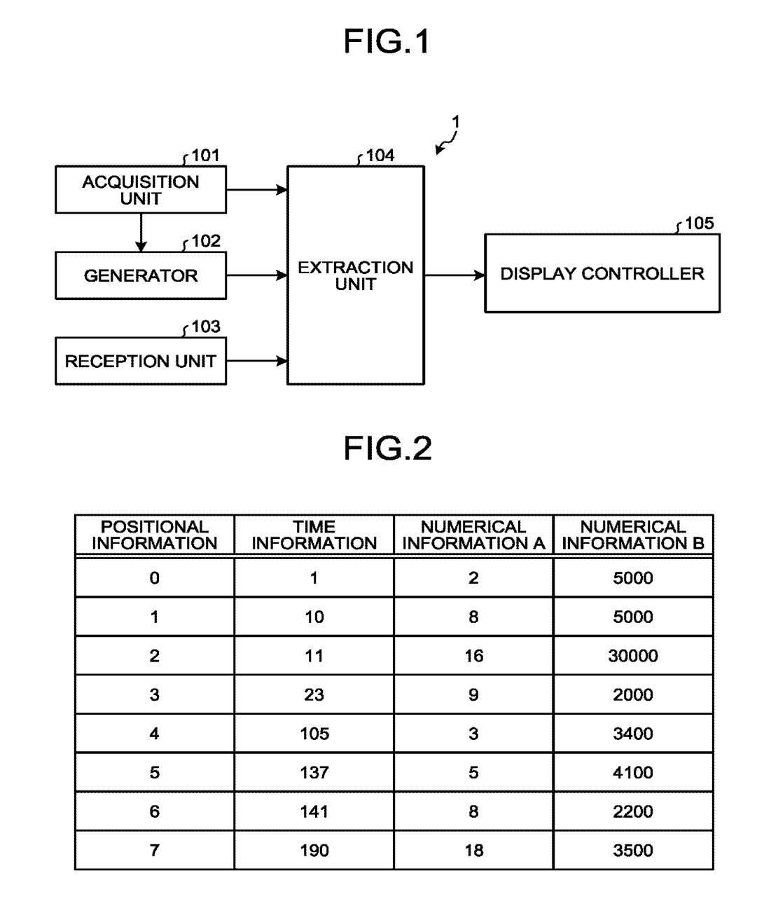

FIG. 1 is a diagram illustrating an example of a functional configuration of an information processing system 1 according to an embodiment. The information processing system 1 in the embodiment includes an acquisition unit 101, a generator 102, a reception unit 103, an extraction unit 104, and a display controller 105.

The information processing system 1 in the embodiment will be described with an example of a situation of generating display information, for which time information is mapped on an X axis and information generated from numerical information is mapped on a Y axis, by using time series information for which the time information is associated with the numerical information. The information processing system 1 receives any desired range of time information from the reception unit 103 and generates the display information by using the numerical information corresponding to the time information.

Conventionally, in such an information processing system, there has been a problem in that, although the range on the X axis (time information) is easily obtainable from the information input from the reception unit 103, the maximum value and the minimum value on the Y axis (numerical information) corresponding to the range of the time information are not found unless all pieces of the numerical information corresponding to the range of the time information are checked. In the case where it is possible to freely perform zoom-in or zoom-out on the X axis, that is, the range of the time information, by a user input, it is not possible to display a chart corresponding to the zoom operation fast, because it needs to search all of the relevant ranges in the time series information and determine the maximum value and the minimum value on the Y axis, each time the range on the X axis is changed.

Consequently, in the information processing system 1 in the embodiment, the generator 102 generates, from the time series information, index information including the maximum value and the minimum value of the numerical information in a certain time range, and generates the display information fast by using the index information.

The acquisition unit 101 acquires the time series information. The time series information includes data for which the time information is associated with the numerical information.

Example of Time Series Information

FIG. 2 is a diagram illustrating an example in the time series information in the embodiment. The time series information in the embodiment includes data for which positional information, the time information, numerical information A, and numerical information B are associated with one another. The positional information is the information indicative of the position of data included in the time series information. The time information indicates the time that the numerical information A and the numerical information B were acquired. The way of representing the time information may be in any desired manner. In the example in FIG. 2, the time information is a count value. The numerical information A and the numerical information B may be any information. For example, the numerical information A is the information indicative of the number of goods, and the numerical information B is the information indicative of sales. The number of pieces of the numerical information stored as the time series information is not limited to two, and it may be one or three or more. The time series information may include no positional information.

The acquisition unit 101 inputs the time series information into the generator 102 and the extraction unit 104. The acquisition method of the time series information may be in any desired manner. The time series information may be acquired from the own device or may be received from other devices.

The generator 102 generates, upon receiving the time series information from the acquisition unit 101, the index information from the relevant time series information. The index information is the information that is generated based on the time series information.

For example, it is possible to generate the index information by aggregating the time series information. The index information includes information on tabulation category and information on tabulation result. In aggregating the time series information, tabulation information is generated, by dividing the information on tabulation category into certain sections, and by using values of the tabulation result corresponding to each section. For example, in the case of the time series information in FIG. 2, the time information can be used as the tabulation category, and the numerical information A, the numerical information B, or both of the numerical information A and the numerical information B can be used as the tabulation result.

Example of Index Information

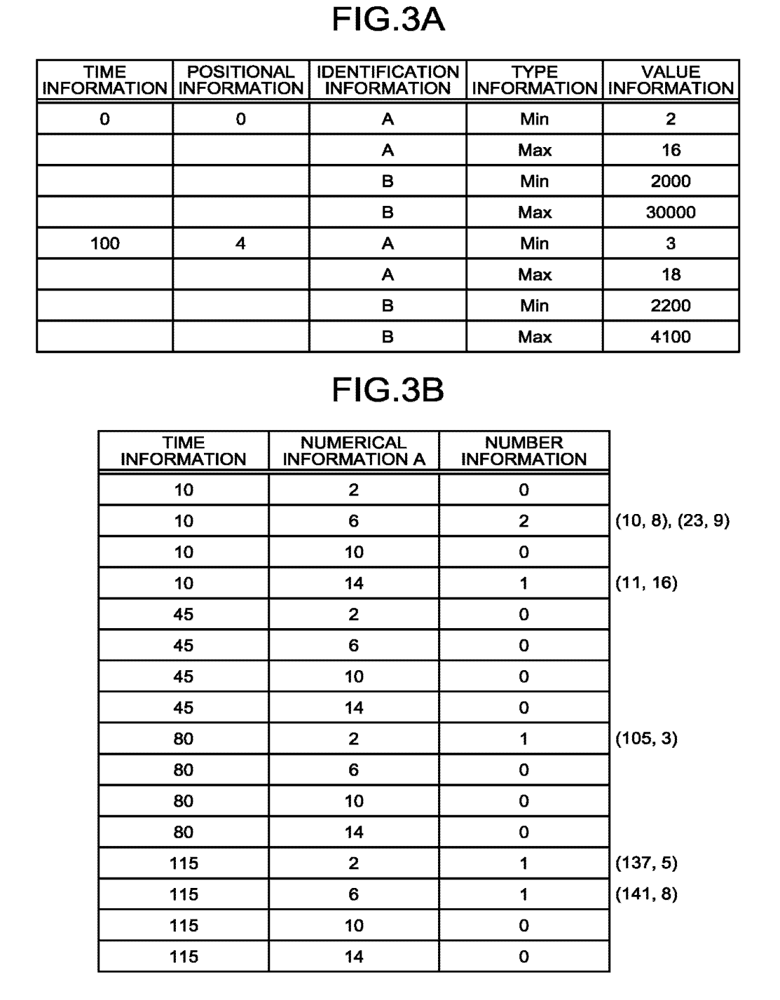

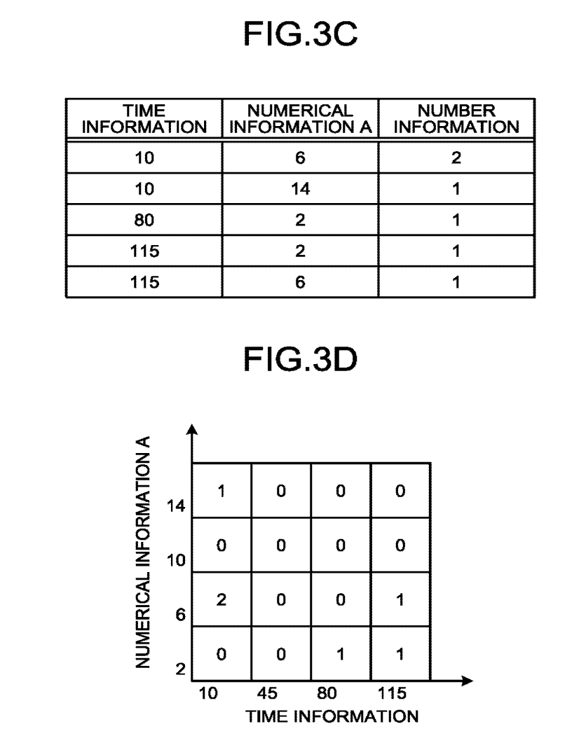

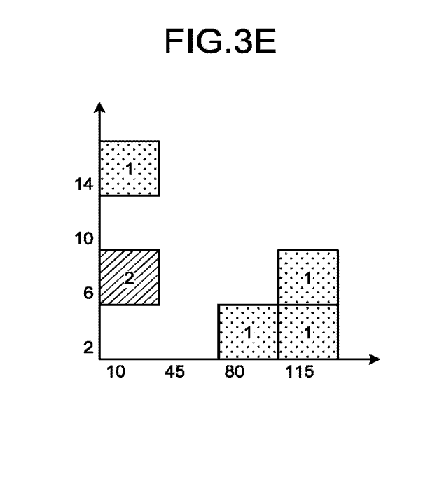

FIG. 3A illustrates one example of the index information generated from FIG. 2. The index information includes data for which the time range of the time information is associated with the tabulation information that is tabulated for each time range of the relevant time information (see FIG. 3A), for example. In this case, the information on the tabulation category is the time information, and the information on the tabulation result is the numerical information A and the numerical information B. The tabulation information is a minimum value and a maximum value, for example.

FIG. 3A is a diagram illustrating the index information in the embodiment. The index information in the embodiment includes data for which the time information, the positional information, identification information, type information, and value information are associated with one another. The time information indicates the start time of a certain time range. The positional information indicates the positional information on the above-described time series information. The identification information is the identification information that identifies the numerical information. In FIG. 3A, A represents the numerical information A, and B represents the numerical information B. The type information is the information indicative of a tabulation method of the tabulation information that was tabulated for each time range of the time information. In FIG. 3A, Min represents a minimum value and Max represents a maximum value. The value information indicates the value of the tabulation information.

The tabulation information may further hold, not only the minimum value and the maximum value, other tabulation results, for example, a value obtained by performing statistic calculation on the numerical information. The value obtained by statistic calculation is a statistical value such as a representative value, for example. The representative value is an average value, a median value, a mode value, and others of the foregoing, for example. The tabulation information may be the number of pieces of the numerical information, the sum of the numerical information, and others, for example.

The data format of the index information is not limited to the above-described table format, and may be in any desired format. The index information may be stored by the records of a relational database (RDB), for example.

Although it is preferable that the generation of index information by the generator 102 be performed only once on the time series information that the acquisition unit 101 acquired, it is conceivable that there is a case that, when the units of aggregation of the tabulation category are changed, the generation is performed again on the same time series information, for example.

The above-described range of the units of aggregation does not need to he at equal intervals. For example, when the tabulation category is represented on a logarithmic axis, it is preferable that the units of aggregation be at a certain interval on the logarithmic axis. The range of the units of aggregation is not limited to these and may be at any desired intervals. As for the range of the units of aggregation, the size of the time range may be changed, depending on the amount of log data indicative of the time series information, for example. The time range of the time zone for which the amount of log data is large may be made shorter than the time range of the time zone for which the amount of log data is small, for example. Accordingly, it is also possible to adjust the amount of time series information, on which tabulation processing is performed for each time range, to be in a certain range, for example.

Referring back to FIG. 1, the generator 102 inputs the index information into the extraction unit 104. The generator 102 may, without generating the index information by the own device, acquire the index information generated by the other devices.

The reception unit 103 inputs, upon receiving a start time and an end time in response to the input operation of the user and the like, the start time and the end time into the extraction unit 104. The reception unit 103 may further receive the identification information on the numerical information.

The extraction unit 104 receives the time series information from the acquisition unit 101, receives the index information from the generator 102, and receives the start time and the end time from the reception unit 103. The extraction unit 104 then, by using the index information, extracts the tabulation information (the maximum value and the minimum value) on the numerical information corresponding to the time range between the start time and the end time, from the tabulation information tabulated between the time range that includes the start time and the time range that includes the end time.

Furthermore, when the identification information on the numerical information has been received by the reception unit 103, the extraction unit 104 extracts, by using the index information, the tabulation information (the maximum value and the minimum value) on the numerical information identified by the identification information, from the tabulation information tabulated between the time range that includes the start time and the time range that includes the end time.

In the example in FIG. 3A, the tabulation information on the numerical information is the minimum value and the maximum value of the numerical information A, and the minimum value and the maximum value of the numerical information B.

The processing of the extraction unit 104 is specifically described with an example of the case where the start time=10, the end time=150, and the identification information=A were received from the reception unit 103. The extraction unit 104 refers to the index information in the time range including the time range (10-150) received from the reception unit 103 and extracts the minimum value and the maximum value of the numerical information A. First, the extraction unit 104 refers to the index information, and extracts the minimum value=2 and the maximum value=16 of the numerical information A that has been tabulated in the time range (0-99) including the start time=10. Next, the extraction unit 104 refers to the index information, and extracts the minimum value=3 and the maximum value=18 of the numerical information A that has been tabulated in the time range (100-199) including the end time=150. The extraction unit 104 compares the values obtained in the foregoing, and obtains the minimum value=2 and the maximum value=18 as the tabulation information on the numerical information A.

The minimum value=2 extracted from the index information by the above-described information processing method is equivalent to the minimum value of the numerical information A in the time range of 0-199. Because the time range of 0-199 includes but is wider than the time range (10-150) received by the reception unit 103, there is a possibility that the minimum value=2 is smaller than the minimum value of the numerical information A in the time range (10-150) received by the reception unit 103. In the same manner, there is a possibility that the maximum value=18 extracted from the index information by the above-described information processing method is greater than the maximum value of the numerical information A in the time range received by the reception unit 103. However, it can be considered that, in the case that high processing speed is more desired than high accuracy of the range of the value of the numerical information A, there is no problem unless the range is narrower than the range of accurate values. The information processing method in the embodiment can obtain a noticeable effect in the increase in the processing speed of extracting approximate tabulated values of the numerical information included in the designated time range, when the amount of data of the time series information is enormous, for example.

The units of aggregation in the index information are not limited to 100 each. The units of aggregation may be 50 each, for example. When the units of aggregation are 50 each, and the start time=10, the end time=150, and the identification information=A are received by the reception unit 103, the extraction unit 104 refers to the minimum values and the maximum values of the numerical information A tabulated in the time range of 0-49, 50-99, 100-149, and 150-199.

Furthermore, when the number of data included in the time series information is equal to or less than a threshold, the extraction unit 104 may directly extract, from the time series information, the tabulation information (the minimum value and the maximum value, for example) on the numerical information. That is, when the number of data of the time series information is equal to or less than the threshold, because it is possible to expect that the processing time for directly referring to the time series information is small, a method that prioritizes the accuracy of the value of the tabulation information can be considered.

The extraction unit 104 inputs the tabulation information thus extracted into the display controller 105. The extraction unit 104 further inputs the partial time series information included between the start time and the end time into the display controller 105.

The display controller 105 performs display control of the display information based on the tabulation information and the partial time series information received from the extraction unit 104. The display controller 105 outputs the display information to a graphical user interface (GUI) system that is connected to the information processing system 1. The display controller 105 may output the display information that the partial time series information is plotted on a graph having an X axis for which the range was determined based on the time range input from the reception unit 103 and having a Y axis for which the range was determined based on the tabulation information (the maximum value and the minimum value of the numerical information A) received from the extraction unit 104.

The display information may be generated by aggregating the partial time series information. For example, when the number of data is greater than the resolution of a display in the GUI system or greater than the number of pixels of a display window, by aggregating the partial time series information and reducing the number of data to be displayed, it is possible to shorten the time it takes for displaying or to prevent the display image from being excessively fine. In FIG. 3B, an example of aggregating the information by generating number information from the partial time series information will be described.

Example of Displaying Time Series Information

FIG. 3B illustrates an example of display information that the display controller 105 outputs. This example indicates, in combination of the ranges of respective values of the time information and the numerical information A, the number of relevant data in the time series information. It is assumed that, on the GUI system, the time information is mapped on the X axis and the numerical information A is mapped on the Y axis, and that the minimum value and the maximum value on the X axis are the start time and the end time designated by the reception unit 103. The resolution of each of the X axis and the Y axis is 4.

The display controller 105 first performs calculation concerning the time information. That is, the display controller 105 calculates the ranges for which the range of the time information from the start time to the end time is divided into four. As the start time=10 and the end time=150, the range is divided into 35 each and into four ranges of 10-44, 45-79, 80-114, and 115-150.

The display controller 105 then performs calculation concerning the numerical information A. That is, the display controller 105 calculates the ranges for which the range of the minimum value 2 and the maximum value 18 that were input from the extraction unit 104 divided into four. For example, as the ranges of the numerical information A, four ranges of 2-5, 6-9, 10-13, and 14-18 are set.

The display controller 105 calculates, for each combination of the foregoing calculated ranges of the time information and the numerical information A, the number of data present in the time series information and outputs the display information illustrated in FIG. 3B. As the data in the range of 10-44 of the time information and in the range of 2-5 of the numerical information A, there are two data of the time information=10 and the time information=23. As the data in the range of 10-44 of the time information and in the range of 14-18 of the numerical information A, there is one data of the time information=11. As the data in the range of 80-114 of the time information and in the range of 2-5 of the numerical information A, there is one data of the time information=105. As the data in the range of 115-150 of the time information and in the range of 2-5 of the numerical information A, there is one data of the time information=137. As the data in the range of 115-150 of the time information and in the range of 6-9 of the numerical information A, there is one data of the time information=141.

While an example of the display information indicative of all of the combinations of the ranges concerning the time information and the numerical information A is illustrated in FIG. 3B, the display information indicative of only the combinations of the ranges having one or more pieces of data as in FIG. 3C is also conceivable. In addition to that, as long as it is the information for displaying the ranges in the time series information designated by the reception unit 103, the method of calculation and the format of representation do not matter.

FIG. 3D is a chart that the GUI system displayed based on the display information. The time information is represented on the X axis and the numerical information A is represented on the Y axis, and it is displayed by dividing the axes into the ranges of four each. It displays the number of data in the time series information in the relevant ranges based on the display information. It can tell at a glance that, in the range for which the time information starts from 10 and is below 45 and the range for which the numerical information A starts from 6 and is below 10, there are two data.

FIG. 3E illustrates another example of the display made by the GUI system. In place of displaying all of the number of data in the respective ranges, objects are drawn only in the ranges that the number of data is one or more. In addition, based on the size of the number of pieces, the objects are expressed in dark colors when the number of pieces is large, and are expressed in light colors when the number of pieces is small.

In the present GUI system, when it is possible to freely perform zoom-in or zoom-out on the X axis, that is, the range of time information, by the user input, it is possible, as for the X axis, to calculate the range easily from the information that was input. As for the Y axis also, it is possible for the extraction unit 104 to extract, based on the index information, the maximum value and the minimum value relevant to the range of the time information fast. When the function of extracting, based on the index information, the maximum value and the minimum value on the Y axis not available, it is not possible to display a chart corresponding to the zoom operation fast, because it needs to search all of the relevant ranges in the time series information and determine the maximum value and the minimum value on the Y axis (that is, it takes time for the processing of the extracting unit 104), each time the range on the X axis is changed. This effect is more noticeable as the number of relevant data in the time series information is larger.

Next, the information processing method in the embodiment will be described.

Example of Information Processing Method

First, an overall flow illustrating the information processing method in the embodiment will be described.

Overall Flow

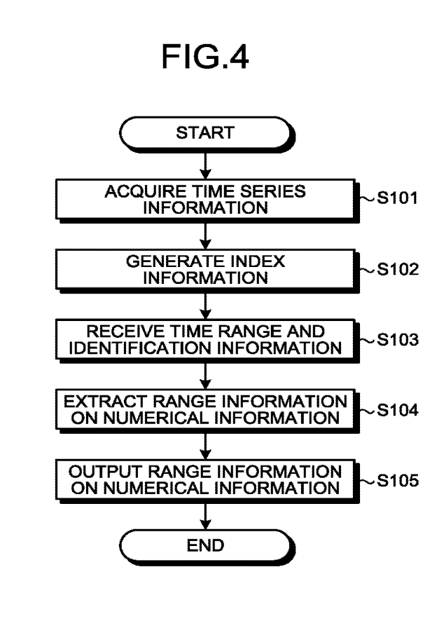

FIG. 4 is an overall flowchart illustrating an example of the information processing method in the embodiment. The example in FIG. 4 illustrates a case that the tabulation information is the range information indicative of the minimum value and the maximum value in the numerical information. First, the acquisition unit 101 acquires the time series information (see FIG. 2) (Step S101).

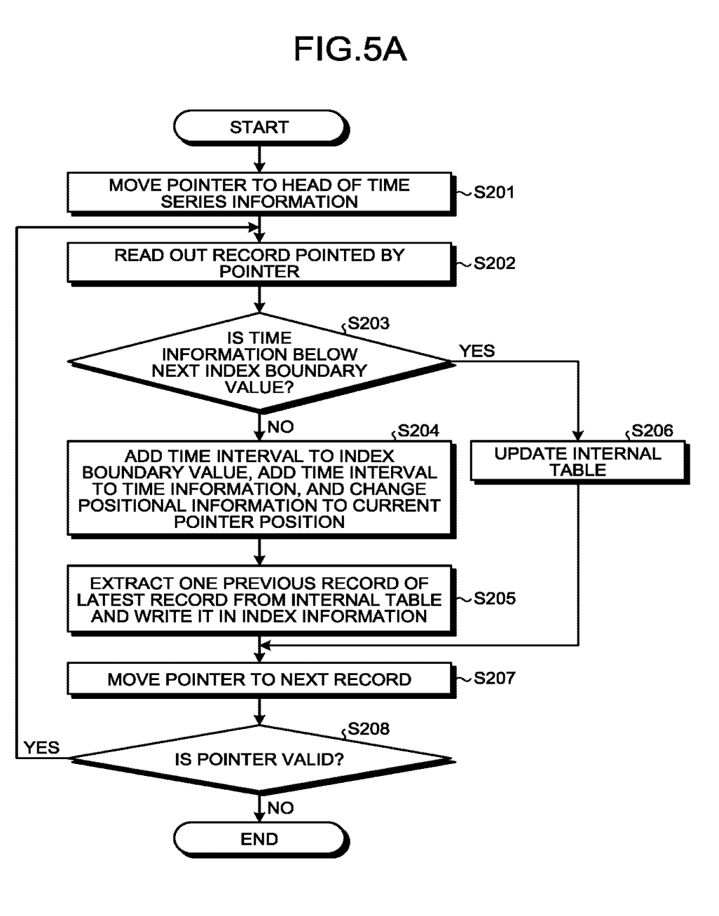

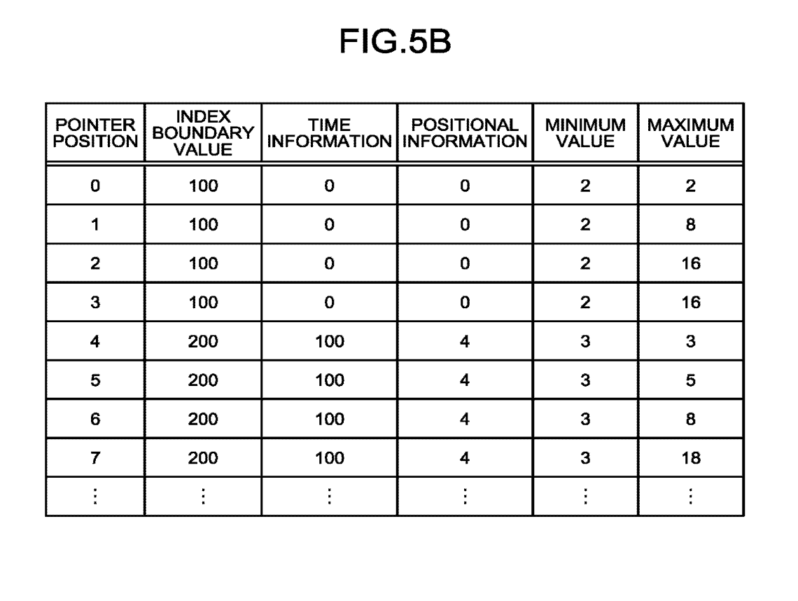

Then, the generator 102 generates the index information (see FIG. 3A) from the time series information acquired by the processing at Step S101 (Step S102). The detail of the generation method of index information will be described later with reference to FIGS. 5A and 5B.

The reception unit 103 then receives the time range including the start time and the end time, and the identification information on the numerical information (Step S103).

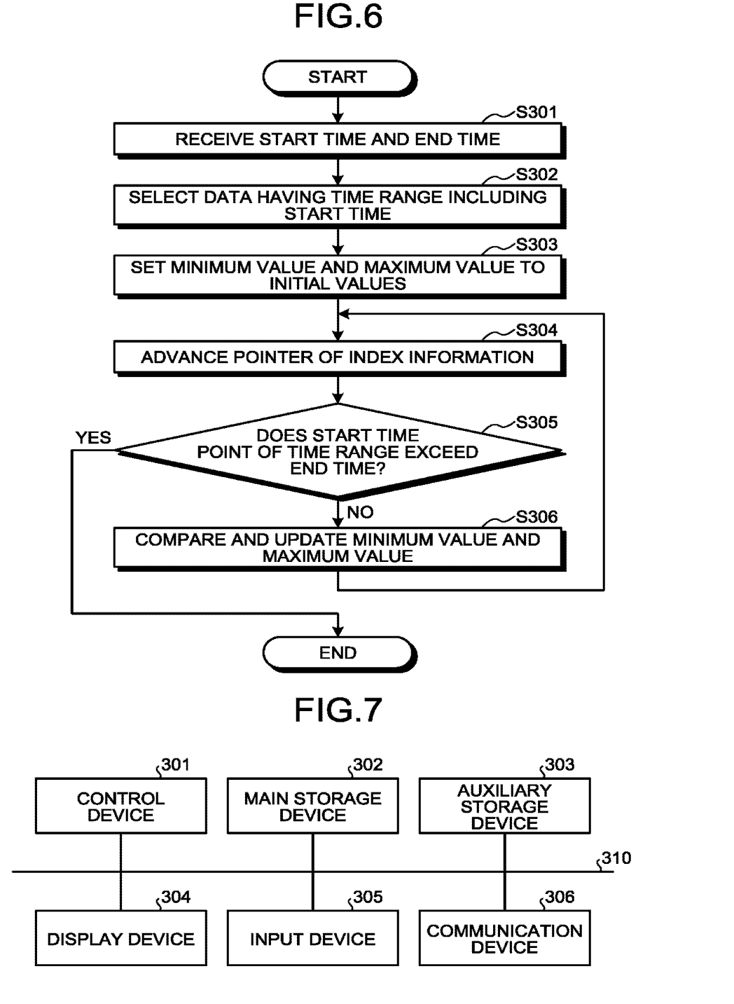

Then, the extraction unit 104 extracts, by using the index information, the range information (the minimum value and the maximum value) on the numerical information identified by the identification information received by the processing at Step S103 (Step S104). The detail of the extraction method of range information will be described later with reference to FIG. 6. Step S101 to Step S104 are not necessarily executed every time. For example, if the room operation is performed to the same input data plurality times, it is possible to execute Step S101 to Step S105 at the first time and execute only Step S103 to Step S105 from the second time. Steps S101 and S102 can be omitted from the second time.

The display controller 105 then, based on the time series information and on the range information extracted by the processing at Step S104, outputs the display information to the GUI system and others (Step S105).

Next, the detail of the generation method of index information will be described. It is specifically described with an example of a case where the index information in FIG. 3A is generated from the time series information illustrated in FIG. 2.

Generation Method of Index Information

FIG. 5A is a flowchart illustrating a sequence of processing in acquiring the index information from trace information. FIG. 5B is a diagram illustrating an internal table used in acquiring the index information from the trace information. The internal table is a table that is used in internal processing when the index information is acquired. By writing into the index information a part of the data written in the internal table, the index information is updated.

The internal table in FIG. 5B includes a pointer position, an index boundary value, the time information, the positional information, the minimum value, and the maximum value. The example in FIG. 5B illustrates a case when the tabulation information (the minimum value and the maximum value) on the numerical information A identified by identification information A is obtained.

The tabulation information (the minimum value and the maximum value) on the numerical information B identified by identification information B can be obtained in the same manner as that in the case of the numerical information A. Thus, in the following description, for simplicity, it will be described with an example a case when the tabulation information on the numerical information A is obtained.

First, the generator 102 moves the pointer to the head (positional information=0) of the time series information (Step S201). The generator 102 then reads out a record that the pointer points (Step S202).

Then, generator 102 determines whether the time information included in the record read out by the processing at Step S202 is below a next index boundary value (Step S203). The index boundary value indicates the boundary of the range in the units of aggregation. In the example in FIG. 3A, the index boundary values are 0 and 100 that indicate the boundaries of the time ranges on the time information.

If the time information is below the next index boundary value (Yes at Step S203), the generator 102 updates the internal table in FIG. 5B (Step S206).

The processing at Step S206 will be described specifically with an example of the case of the first to fourth records in FIG. 5B.

The first record in FIG. 5B is generated when the record of up to the head (positional information=0) of the time series information in FIG. 2 is read out. The pointer position=0 indicates the position of the pointer pointing the time series information. The index boundary value indicates a time boundary 100 of the next time range (100-199). The time information, the positional information, the minimum value, and the maximum value respectively correspond to the time information, the positional information, the minimum value, and the maximum value of the index information in FIG. 3A. At the time point at which the record of up to the head (positional information=0) of the time series information has been read out, each of the minimum value and the maximum value of the numerical information A is 2.

The second record in FIG. 5B is generated when up to the second record (positional information=1) of the time series information in FIG. 2 is read out. In the second record, the pointer position has been updated from 0 to 1 and the maximum value of the numerical information A has been updated from 2 to 8.

The third record in FIG. 5B is generated when up to the third record (positional information=2) of the time series information in FIG. 2 is read out. In the third record, the pointer position has been updated from 1 to 2 and the maximum value of the numerical information A has been updated from 8 to 16.

The fourth record in FIG. 5B is generated when up to the fourth record (positional information=3) of the time series information in FIG. 2 is read out. In the fourth record, the pointer position has been updated from 2 to 3.

If the time information is equal to or greater than the next index boundary value (No at Step S203), the generator 102 adds a time interval (100) to the index boundary value, adds the time interval (100) to the time information, changes the positional information to the current pointer position, and generates a record in which the values of the numerical information A indicated by the current pointer position in the time series information are registered into the minimum value and the maximum value (Step S204). The record generated by the processing at Step S204 is the fifth record in the example in FIG. 5B.

The fifth record in FIG. 5B is generated when up to the fifth record (positional information=4) of the time series information in FIG. 2 is read out. In the fifth record, the pointer position has been updated from 3 to 4, the index boundary value has been updated from 100 to 200, the time information has been updated from 0 to 100, and the positional information has been updated from 0 to 4. In the minimum value and the maximum value, 3, which is the value of the numerical information A in the record of the positional information=4, is registered.

Then, the generator 102 extracts one previous record of the latest record from the internal table, and writes the relevant record into the index information (Step S205). The records written to the index information by the processing at Step S205 are the fourth record (pointer position=3) and the eighth record (pointer position=7), in the example in FIG. 5B.

Then, the generator 102 moves the pointer indicative of the record of the time series information to the next record (Step S207). The generator 102 then determines whether the pointer that was moved by the processing at Step S207 is valid (Step S208). If the pointer is valid (Yes at Step S208), the processing is returned to Step S202. If the pointer is not valid (No at Step S208), the processing is ended.

In FIG. 5B, in consideration of the ease of understanding, the processing of generating the index information by the internal table has been illustrated. However, in order to minimize the amount of memory used in the processing, the way to advance the processing while holding only two records of the internal table is also conceivable. When the pointer position was advanced at S204, because the records of two previous pointer positions and earlier are never used, they may be deleted. For example, at the time point when the pointer position is advanced to 3, even if the record relevant to the pointer position=1 is deleted, the index information can be generated properly. As just described, the index generation in the generator 102 is not limited to the present example, and it may be any desired method as long as it is a processing method capable of generating the index information.

Next, the detail the extraction method of range information on the numerical information in the embodiment will be described.

Extraction Method of Range Information

FIG. 6 is a flowchart illustrating an example of the extraction method of range information on the numerical information in the embodiment. First, the extraction unit 104 receives the start time and the end time from the reception unit 103 (Step S301). Then, the extraction unit 104 selects data having the time range that includes the tart time from the index information (Step S302). The extraction unit 104 then sets the minimum value and the maximum value included in the data selected by the processing at Step S302 to the initial values of the range information (Step S303).

Then, by advancing the pointer of the index information, the extraction unit 104 moves on to the data indicative of the next time range (Step S304). The extraction unit 104 then determines whether the start time point of the time range included in the data exceeds the end time received by the processing at Step S301 (Step S305).

If it exceeds the end time (Yes at Step S305), the processing is ended.

If it does not exceed the end time (No at Step S305), the extraction unit 104 performs the comparison and updating of the minimum value and the maximum value (Step S306). Specifically, when the minimum value included in the referring data is smaller than the currently held minimum value, the extraction unit 104 updates the minimum value of the range information. When the maximum value included in the referring data is greater than the currently held maximum value, the extraction unit 104 updates the maximum value of the range information. After Step S306, the processing is returned to Step S304.

Lastly, an example of a hardware configuration of the information processing system in the embodiment will be described.

Example of Hardware Configuration

FIG. 7 is a diagram illustrating an example of the hardware configuration of the information processing system 1 in the embodiment. The information processing system 1 in the embodiment includes a control device 301, a main storage device 302, an auxiliary storage device 303, a display device 304, an input device 305, and a communication device 306. The control device 301, the main storage device 302, the auxiliary storage device 303, the display device 304, the input device 305, and the communication device 306 are connected via a bus 310.

The control device 301 executes a computer program that is read out from the auxiliary storage device 303 to the main storage device 302. The control device 301 is one or more processors such as a CPU, for example. The main storage device 302 is a memory such ac a read only memory (ROM) and a random access memory (RAM). The auxiliary storage device 303 is a memory card, a hard disk drive (HDD), and others.

The display device 304 displays information. The display device 304 is a liquid crystal display, for example. The input device 305 receives the input of information. The input device 305 is a keyboard, a mouse, and others, for example. The display device 304 and the input device 305 may be a liquid crystal touch panel or the like that assumes both the display function and the input function. The communication device 306 performs communication with other devices.

The program executed in the information processing system 1 in the embodiment is recorded in a computer-readable recording medium such as a CD-ROM, a memory card, a CD-R, and a digital versatile disc (DVD) in a file of an installable or executable format and provided as a computer program product.

Furthermore, the program executed in the information processing system 1 in the embodiment may be stored in a computer connected to a network such as the Internet, and be provided by downloading via the network. The program that the information processing system 1 in the embodiment executes may be provided, without downloading, via a network such as the Internet.

The program executed in the information processing system 1 in the embodiment may be provided by embedding in a ROM or the like in advance.

The program executed in the information processing system 1 in the embodiment is in a modular configuration including, out of the functional configuration of the information processing system 1 in the embodiment, the functions that can be implemented by the program.

The functions that are implemented by the program are loaded on to the main storage device 302, by reading out and executing the program from a storage medium such as the auxiliary storage device 303 by the control device 301. That is, the functions implemented by the program are generated on the main storage device 302.

A part of the functions of the information processing system 1 in the embodiment may be implemented by the hardware such as an integrated circuit (IC). The IC is a processor that executes dedicated processing, for example.

When various functions are implemented by using a plurality of processors, each processor may implement one out of the various functions or may implement two or more out of the various functions.

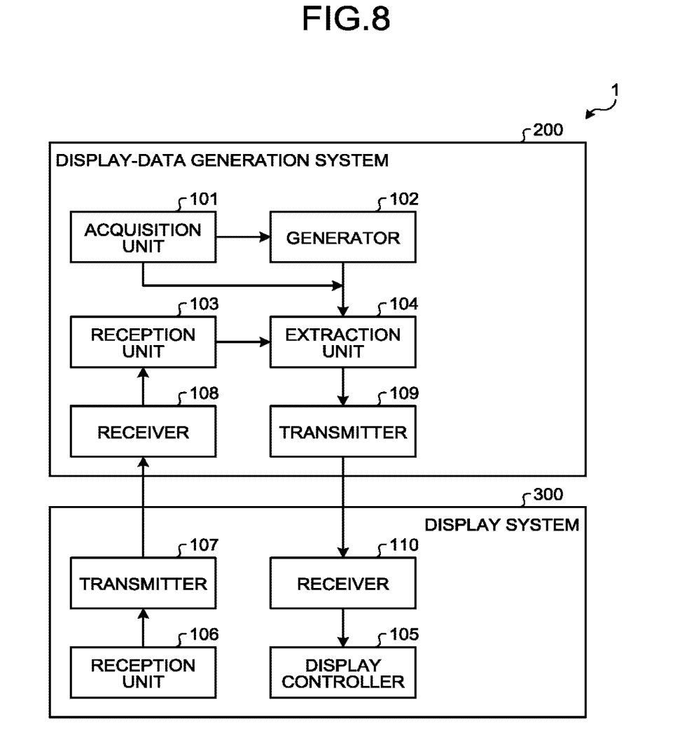

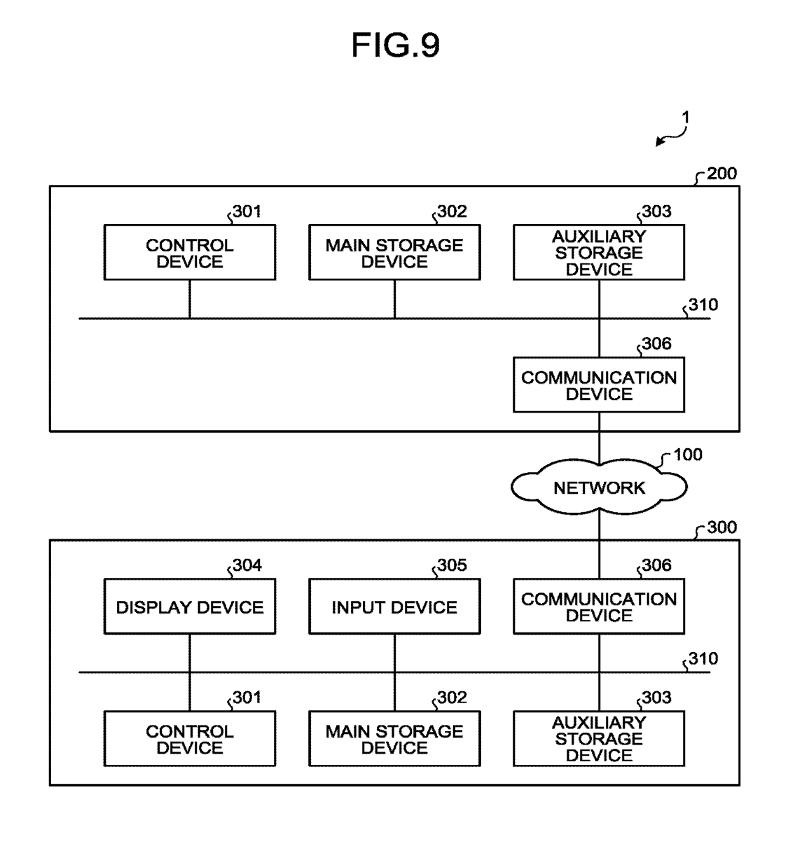

The operation mode of the information processing system 1 in the embodiment may be in any desired mode. The information processing system 1 in the embodiment may be made to operate as a cloud-computing system on a network, for example. By separating the information processing system 1 into a display-data generation system 200 and a display system 300 as illustrated in FIG. 8, the display system 300 (a client) and the display-data generation system 200 (a server) may be separated via a network 100 (see FIG. 9), for example. The display-data generation system 200 and the display system 300 that are separated each other have a transmitter 109 and a receiver 108, and a transmitter 107 and a receiver 110, respectively, for transmitting/receiving each other. In this case, the hardware configuration is represented as in FIG. 9. In FIG. 8, an example in which a reception unit 106 and the display controller 105 are arranged in the display system 300 (the client) is illustrated. However, the embodiment is not limited thereto. It may be configured such that, by arranging the display controller 105 in the display-data generation system 200 (the server), the display system 300 (the client) receives the display information from the display controller 105 and displays it on the display. The reception unit 106 and the display may be arranged on a separate terminal.

As in the foregoing, according to the information processing system 1 in the embodiment, the reception unit 103 receives the start time and the end time. The extraction unit 104 extracts the tabulation information on the numerical information, from the tabulation information tabulated between the time range that includes the start time and the time range that includes the end time. The extraction unit 104 uses the time series information including the data for which the time information is associated with the numerical information and the index information including the data for which the time range of the time information is associated with the tabulation information tabulated for each time range of the time information, refers to the tabulation information associated with the time information between the time range including the start time and the time range including the end time, and extracts the tabulation information corresponding to a period between the start time and the end time.

Thus, according to the information processing system 1 in the embodiment, it is possible to further increase the processing speed when using the tabulation information obtained from the time series information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
one or more memories; and
one or more processors coupled to the memories and configured to:
receive a start time and an end time; and
use time series information including data for which time information is associated with numerical information and index information including data for which a time range of the time information is associated with tabulation information tabulated for each time range of the time information, refer to the tabulation information associated with time information between the time range including the start time and the time range including the end time, and extract the tabulation information corresponding to a period between the start time and the end time.

2. The system according to claim 1, wherein
the tabulation information includes at least a minimum value and a maximum value of the numerical information, and
the extracting extracts range information indicative of a range of values of the numerical information from the tabulation information.

3. The system according to claim 1, wherein the extracting extracts tabulation information on the numerical information from the time series information when number of data included in the time series information is equal to or less than a threshold.

4. The system according to claim 1, wherein
the recepting further receives identification information identifying the numerical information, and
the extracting extracts, from the tabulation information tabulated between the time range including the start time and the time range including the end time, tabulation information on the numerical information identified by the identification information.

5. The system according to claim 1, the one or more processors are further configured to generate, from the index information, display information including a first axis indicative of the time information and one or more second axes indicative of the tabulation information and perform display control of the display information.

6. An information processing method comprising:
receiving a start time and an end time; and
extracting, by using time series information including data for which time information is associated with numerical information and index information including data for which a time range of the time information is associated with tabulation information tabulated for each time range of the time information, and by referring to the tabulation information associated with time information between the time range including the start time and the time range including the end time, the tabulation information corresponding to a period between the start time and the end time.

7. A computer program product having a non-transitory computer-readable medium including programmed instructions, wherein the instructions, when executed by a computer, cause the computer to function as:
a reception unit configured to receive a start time and an end time; and
an extraction unit configured to use time series information including data for which time information is associated with numerical information and index information including data for which a time range of the time information is associated with tabulation information tabulated for each time range of the time information, refer to the tabulation information associated with time information between the time range including the start time and the time range including the end time, and extract the tabulation information corresponding to a period between the start time and the end time.
